(19) United States
(12) Patent Application Publication
(10) Pub. No.: US 2012/0224740 A1
(43) Pub. Date: Sep. 6, 2012

(54) SPEAKER WITH MAGNETIC FIELD ENHANCING WASHER AND DISK

(75) Inventor: HWANG-MIAW CHEN, Tu-Cheng (TW)

(73) Assignee: HON HAI PRECISION INDUSTRY CO., LTD., Tu-Cheng (TW)

(21) Appl. No.: 13/470,374

(22) Filed: May 14, 2012

Related U.S. Application Data
(63) Continuation-in-part of application No. 13/080,608, filed on Apr. 5, 2011.

(30) Foreign Application Priority Data
Dec. 21, 2010 (CN) 201010598764.7

(51) Int. Cl. H04R 1/00

(52) U.S. Cl. 381/433

(57) ABSTRACT

An exemplary speaker includes a yoke having a bottom wall and a sidewall extending upwardly from a periphery of the bottom wall. The speaker further includes a supporting post, a first magnet, a disk and a second magnet sequentially stacked on the bottom wall, and a washer attached on the sidewall and surrounding the disk. A magnetic gap is defined between the washer and the disk. A voice coil is partly received in the magnetic gap. A diaphragm is attached to the voice coil.

### CROSS-REFERENCE TO RELATED APPLICATIONS

The present application is a continuation-in-part (CIP) application of patent application Ser. No. 13/080,608 entitled “SPEAKER AND YOKE THEREOF” and filed on Apr. 5, 2011, whose disclosure is incorporated herein by reference in its entirety.

### BACKGROUND

1. Technical Field

The disclosure generally relates to speakers, and more particularly to a speaker having a washer and a disk providing improved output volume and sensitivity during operation.

2. Description of Related Art

A typical speaker includes a frame, a diaphragm supported by the frame, and a magnetic driving unit. The magnetic driving unit includes a magnet attached to the frame, a magnetic yoke opposing the magnet, and a voice coil disposed between the magnet and the opposing magnetic yoke for driving the diaphragm. In some applications, the size of the speaker is enlarged to increase the output volume and sensitivity of the speaker. However, the volume occupied by the enlarged speaker may be too large for miniaturized applications, and in any event the manufacturing cost of the enlarged speaker is correspondingly increased.

What is needed, therefore, is a speaker to overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead placed upon clearly illustrating the principles of the present embodiments. Moreover, in the drawings, like reference numerals designate corresponding parts throughout the views.

FIG. 1 is a cross-sectional view of a speaker in accordance with a first embodiment of the present disclosure.

FIG. 2 is a cross-sectional view of a speaker in accordance with a second embodiment of the present disclosure.

### DETAILED DESCRIPTION

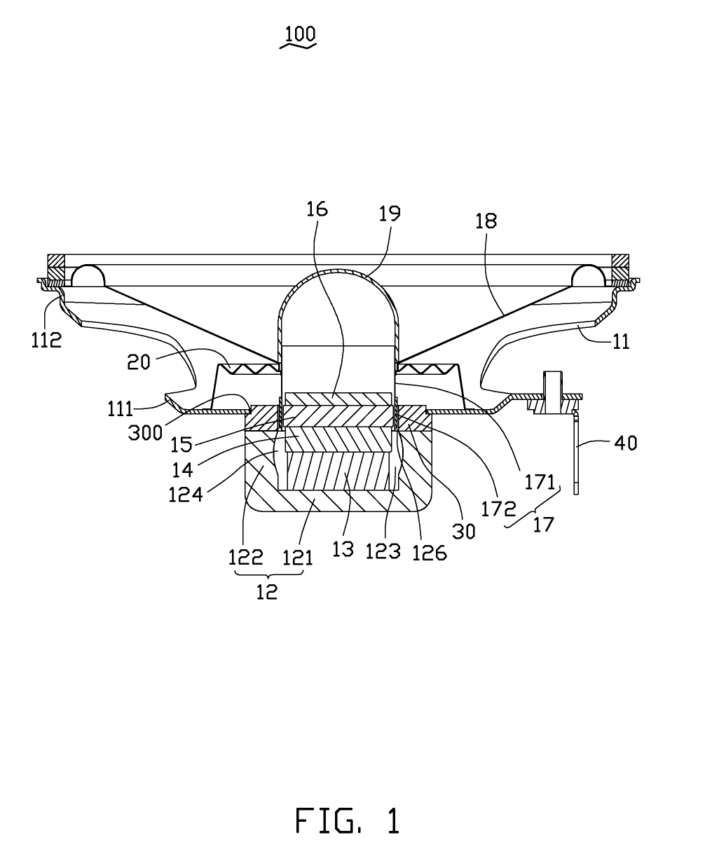

Referring to FIG. 1, a speaker 100 according to a first embodiment of the present disclosure is shown. The speaker 100 includes a frame 11, a yoke 12, a supporting post 13, a first magnet 14, a disk 15, a second magnet 16, a voice coil 17, a diaphragm 18, a dust cap 19, a damper 20, and a washer 30.

The frame 11 is generally horn-shaped, with a bottom small end 111 and a top big end 112. The yoke 12 is connected to the small end 111 of the frame 11 and located below the frame 11. Alternatively, the yoke 12 can be integrally formed with the frame 11 as a single monolithic piece of the same material.

The yoke 12 is cup-shaped and has a U-shaped cross-section. The yoke 12 includes a circular bottom wall 121, and an annular (or cylindrical) sidewall 122 extending upwardly from an outer circumferential periphery of the bottom wall 121. The bottom wall 121 and the sidewall 122 cooperatively define a cylindrical receiving chamber 123 therebetween receiving the supporting post 13 and the first magnet 14 therein. The sidewall 122 defines an annular groove 124 in an inner circumferential surface thereof, the groove 124 surrounding (encircling) an axis of the yoke 12. The groove 124 is located adjacent to a top face of the sidewall 122. A depth of the groove 124 measured in a radial direction of the yoke 12 is gradually increased from a bottommost extremity of the groove 124 upwardly, and reaches a maximum depth at a vertical midpoint of the groove 124, and then is gradually decreased from the vertical midpoint of the groove 124 upwardly to a topmost extremity of the groove 124. In this embodiment, the groove 124 defines an arc-shaped transverse cross-section taken along any radial direction of the yoke 12. In other words, an upper part of the inner circumferential surface of the sidewall 122 in the groove 124 is curved.

The washer 30 is fixed on the top face of the sidewall 122. The washer 30 is annular, and has an inner circumferential surface coincident with a lower part of the inner circumferential surface of the sidewall 122 beneath the groove 124. That is, the inner circumferential surface of the washer 30 and the inner circumferential surface of the sidewall 122 beneath the groove 124 are coaxial, and have the same diameter. An outer circumferential surface of the washer 30 is coincident with that of the sidewall 122. That is, the outer circumferential surface of the washer 30 and the outer circumferential surface of the sidewall 122 are coaxial, and have the same diameter. The washer 30 defines a recess 300 in a top face thereof, adjacent to the outer circumferential surface thereof. The bottom small end 111 of the frame 11 engages in the recess 300 to fix the frame 11 on the washer 30. In a typical embodiment, the recess 300 is in the form of an annular groove, and an inner periphery of the frame 11 is circular.

The supporting post 13, the first magnet 14, the disk 15, and the second magnet 16 each are disc-shaped. A diameter of the supporting post 13 is less than a diameter of the first magnet 14. The diameter of the first magnet 14 is less than a diameter of the disk 15. A diameter of the second magnet 16 is equal to that of the first magnet 14. A thickness of the washer 30 is larger than that of the disk 15, and a thickness of the second magnet 16 is less than that of the first magnet 14. The supporting post 13 is received in the receiving chamber 123 of the yoke 12, and is attached to a top surface of the bottom wall 121 of the yoke 12. The first magnet 14, the disk 15, and the second magnet 16 are sequentially superposed on the supporting post 13.

The yoke 12 and the supporting post 13 may be made of magnetically permeable material, such as steel having low carbon-doping, or stainless steel. The disk 15 and the washer 30 may also be made of magnetically permeable material, such as steel having low carbon-doping, or stainless steel. The disk 15 has a bottom face joining the first magnet 14, and a top face. An outer circumferential surface of the disk 15 faces the inner circumferential surface of the washer 30, with an annular magnetic gap 126 formed therebetween. The top face of the disk 15 is flush with that of the washer 30, and the bottom face of the disk 15 is located higher than that of the washer 30. The disk 15 and the washer 30 can alter the combined magnetic field generated from the first magnet 14 and the second magnet 16 and associated with the supporting post 13 and the yoke 12, so that lines of magnetic force of the magnetic field more densely and uniformly pass through the magnetic gap 126 in horizontal directions perpendicular to the magnetic gap 126. The second magnet 16 is attached on the top face of the disk 15, and is located higher than the washer 30.

The voice coil 17 includes a hollow cylindrical bobbin 171, and a coil 172 wound around a bottom end of the bobbin 171. The voice coil 17 is electrically connected to a circuit board 40 so that electricity flowing through the voice coil 17 can be controlled as desired. The voice coil 17 encloses the second magnet 16 and the disk 15 therein. The coil 172 of the voice coil 17 is mostly interposed into the magnetic gap 126. When the coil 172 is electrified, the coil 172 in the magnetic gap 126 can be driven by the magnetic field to move upwardly or downwardly along axial directions of the speaker 100. The coil 172 of the voice coil 17 is aligned coaxially with the disk 15 and the washer 30, and is located higher than the groove 124 of the yoke 12.

The dust cap 19 is arranged at a top side of the voice coil 17, and is secured to a top end of the bobbin 171 of the voice coil 17. The diaphragm 18 may be made of a resin or a paper material into a cone shape. The diaphragm 18 is arranged in the frame 11, around the dust cap 19. A small end of the diaphragm 18 is secured to the dust cap 19, whereby the diaphragm 18 can move together with the voice coil 17. In other words, the diaphragm 18 can be driven by the upward or downward movement of the voice coil 17 to vibrate along the axial directions of the speaker 100, and thereby generate sound. A big end of the diaphragm 18 is secured to the big end 112 of the frame 11. The damper 20 may be made of a resin-impregnated cloth or a thin resin plate formed into a ring shape. The damper 20 is located between the diaphragm 18 and the small end 111 of the frame 11. The damper 20 encloses the voice coil 17, and connects to the dust cap 19 and the small end 111 of the frame 11. The damper 20 can prevent the voice coil 17 from transverse vibration, thereby improving the quantity of the generated sound.

Due to the cooperation of the disk 15 and the washer 30, the lines of the magnetic force more densely and uniformly pass through the magnetic gap 126. Thus, the voice coil 17 together with the diaphragm 18 can be driven to have a larger vibration amplitude, thereby increasing the power and the sensitivity of the speaker 100 without increasing the size of the speaker 100. Furthermore, due to the presence of the groove 124 in the inner circumferential surface of the sidewall 122 of the yoke 12, the distribution of the lines of magnetic force emanating from the yoke 12 is altered to allow more lines of magnetic force to point towards the coil 172 of the voice coil 17 during operation of the speaker 100. Therefore the amount of magnetic flux passing through the coil 172 of the voice coil 17 is further increased, and may be greatly increased. Accordingly, the output volume and sensitivity of the speaker 100 is further increased. In addition, the depth of the groove 124 is gradually increased and then gradually decreased along an upward direction that is parallel to the axis of the yoke 12. Thus, the distribution of the lines of magnetic force emanating from the yoke 12 towards the coil 172 of the voice coil 17 is smoothly varied to avoid cacophony during operation, thereby reducing or even eliminating sound distortion.

Moreover, in the speaker 100, the second magnet 16 attached on the disk 15 can resist the magnetic force emanating from the first magnet 14 to further increase the amount of magnetic flux passing through the coil 172 of the voice coil 17, thereby further increasing the output volume and sensitivity of the speaker 100.

In the speaker 100, the supporting post 13 is supported between the bottom wall 121 of the yoke 12 and the first magnet 14, to provide sufficient space for the voice coil 17 to vibrate during operation. Alternatively, the supporting post 13 can be omitted, in which case the first magnet 14 is directly attached to the bottom wall 121 of the yoke 12.

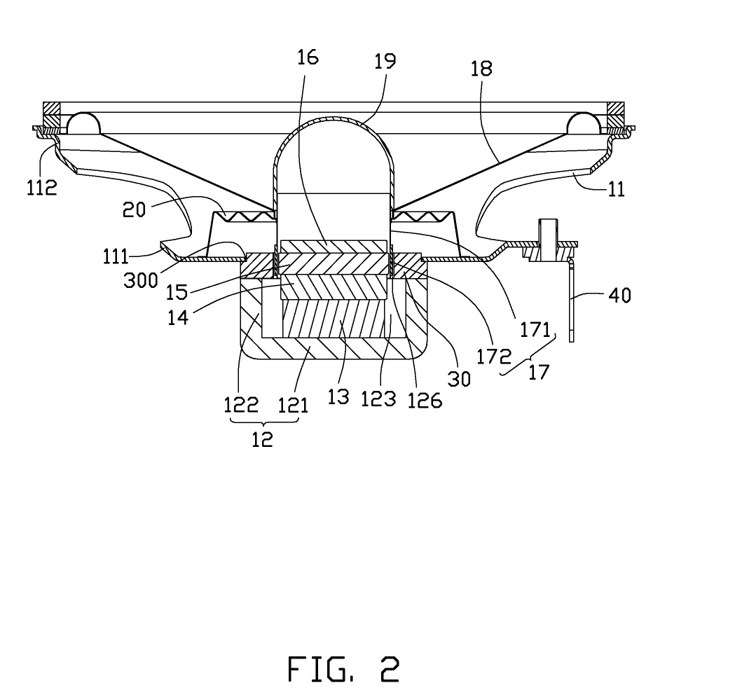

FIG. 2 shows a speaker 100a according to a second embodiment of the present disclosure. The speaker 100a is similar to the speaker 100 of the first embodiment. The only differences between the speakers 100a, 100 relate to the configurations of the sidewall 122. In the speaker 100a, the sidewall 122 of the yoke 12 has a thickness less than that of the speaker 100. The entire inner circumferential surface of the sidewall 122 is substantially annular (or cylindrical), without any groove defined therein. The washer 30 thus protrudes radially inwardly beyond the inner circumferential surface of the sidewall 122. The speaker 100a can achieve similar advantages and effects to those of the speaker 100.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A speaker comprising:
a yoke;
a first magnet attached to the yoke;
a disk fixed relative to the first magnet;
a washer attached to the yoke and surrounding the disk, a magnetic gap defined between the disk and the washer;
a voice coil partly received in the magnetic gap; and
a diaphragm attached to the coil.

2. The speaker of claim 1, wherein the washer has a thickness larger than that of the disk.

3. The speaker of claim 1, wherein an inner circumferential face of the washer faces an outer circumferential face of the disk.

4. The speaker of claim 3, wherein a top face of the washer is substantially level with that of the disk, and a bottom face of the washer is located lower than that of the disk.

5. The speaker of claim 1, wherein the first magnet is located between the disk and the yoke.

6. The speaker of claim 1, wherein the yoke comprises a bottom wall and a sidewall extending upwardly from a circumferential periphery of the bottom wall, the washer being attached on a top face of the sidewall.

7. The speaker of claim 6, wherein the first magnet is attached on a top face of the bottom wall.

8. The speaker of claim 6, wherein the first magnet is attached to a top face of the bottom wall through a supporting post.

9. The speaker of claim 6, wherein the sidewall of the yoke defines a groove in an inner circumferential face thereof, the groove being located adjacent to the washer.

10. The speaker of claim 9, wherein the groove has a depth as measured in a radial direction of the sidewall of the yoke, the depth firstly increasing from a bottom end of the groove to a middle of the groove and then decreasing from the middle of the groove to a top end of the groove.

11. The speaker of claim 9, wherein the inner circumferential face of the sidewall in the groove is curved.

12. The speaker of claim 6, wherein the washer protrudes radially inwardly beyond an inner circumferential face of the sidewall.

13. The speaker of claim 6, further comprising a second magnet, wherein the disk is located between the first magnet and the second magnet.

14. The speaker of claim 13, wherein the second magnet is attached on a top face of the disk and is located higher than the washer.

15. The speaker of claim 13, wherein the second magnet has a thickness less than that of the first magnet.

16. The speaker of claim 1, further comprising a frame, wherein a bottom of the frame is attached to the washer.

17. The speaker of claim 16, wherein the diaphragm has a bottom end attached to the voice coil and a top end attached to a top of the frame.

18. The speaker of claim 17, further comprising a dust cap attached to the bottom end of the diaphragm, wherein the dust cap protrudes upwardly in a direction away from the yoke.

19. The speaker of claim 18, further comprising a damper, wherein the damper has an inner end connecting the voice coil and an outer end attached to the bottom of the frame.

20. The speaker of claim 1, wherein the disk and the washer are made of magnetically permeable material.
